(19) United States
(12) Patent Application Publication
(10) Pub. No.: US 2022/0322462 A1
(43) Pub. Date: Oct. 6, 2022

(54) METHOD AND APPARATUS FOR CONFIGURING EDGE COMPUTING SERVICE INFORMATION

(71) Applicant: Samsung Electronics Co., Ltd., Suwon-si (KR)

(72) Inventors: Hyesung KIM, Suwon-si (KR); Jicheol LEE, Suwon-si (KR)

(21) Appl. No.: 17/714,923

(22) Filed: Apr. 6, 2022

(30) Foreign Application Priority Data
Apr. 6, 2021 (KR) 10-2021-0044818
May 10, 2021 (KR) 10-2021-0060260

(51) Int. Cl. H04W 76/10; H04W 24/02

(52) U.S. Cl. CPC H04W 76/10; H04W 24/02; H04W 80/10

(57) ABSTRACT

The present disclosure relates to a communication method and system for converging a 5^{th}-generation (5G) communication system for supporting higher data rates beyond a 4^{th}-generation (4G) system with a technology for Internet of Things (IoT). The present disclosure may be applied to intelligent services based on the 5G communication technology and the IoT-related technology, such as smart homes, smart buildings, smart cities, smart cars, connected cars, health care, digital education, smart retail, and security and safety services.

### CROSS-REFERENCE TO RELATED APPLICATIONS

This application is based on and claims priority under 35 U.S.C. § 119 to Korean Patent Application Nos. 10-2021-0044818 and 10-2021-0060260, filed on Apr. 6, 2021, and May 10, 2021, in the Korean Intellectual Property Office, the disclosures of which are herein incorporated by reference in their entirety.

### BACKGROUND

### 1. Field

The disclosure relates to a wireless communication system and, more particularly, to a method of configuring edge computing service information for a terminal and a network in a mobile communication system.

### 2. Description of Related Art

To meet the demand for wireless data traffic having increased since deployment of 4 G communication systems, efforts have been made to develop an improved 5G or pre-5G communication system. Therefore, the 5G or pre-5G communication system is also called a “Beyond 4G Network” or a “Post-LTE System.” The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated Multi-Points (CoMP), reception-end interference cancellation and the like. In the 5G system, Hybrid FSK and QAM modulation (FQAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology,” “wired/wireless communication and network infrastructure,” “service interface technology,” and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (RAN) as the above-described big data processing technology may also be considered to be as an example of convergence between the 5G technology and the IoT technology.

Recently, discussion on a method of providing a service to a user equipment (UE) using an edge computing system has been actively conducted. In the edge computing system, a UE may establish a data connection to an edge data network located close to the location of the UE in order to use a low-latency service or a broadband service, and may receive an edge computing service. Such edge computing service may provide a service via an application server that operates in an edge computing platform or an edge hosting environment that operates in an edge enabler server of a predetermined edge data network. That is, the UE may receive an edge computing service from an edge application server that is the closest to an area where the UE is located.

In order to provide an edge computing service, there is a desire for a method of configuring edge computing service information for each edge computing service provider in a mobile communication network that supports edge computing.

The above information is presented as background information only to assist with an understanding of the disclosure. No determination has been made, and no assertion is made, as to whether any of the above might be applicable as prior art with regard to the disclosure.

### SUMMARY

Therefore, the disclosure provides a method and apparatus for configuring edge computing service information in the case in which a user equipment (UE) of a mobile communication network needs to use an edge computing service.

Further, the disclosure provides a method and apparatus for identifying whether edge computing service roaming is supported with respect to a predetermined terminal or a computing service provider (edge computing service provider (ECSP)), and for configuring edge computing service information available in a network to be accessed via roaming.

A user equipment according to the disclosure provides a method of configuring/changing/erasing accessible edge computing service information for a user equipment and a network.

According to the disclosure, different edge computing service providers may be configured according to users. In this scenario, a plurality of ECSPs may be present in different edge computing configuration servers (ECS) in a single operator network, and there is provided a method and apparatus for distinctively configuring information for accessing each ECS with respect to a network and a UE.

Further, the disclosure provides a method of configuring edge computing service information for supporting an edge computing roaming service support scenario among a plurality of mobile communication network operators.

In accordance with an aspect of the disclosure, a single mobile communication operator may provide an edge computing service via a plurality of ECSPs.

According to an embodiment of the disclosure, a single ECSP may conclude an edge computing service agreement with a plurality of mobile communication operators, and may conclude an agreement upon supporting an edge computing service for roaming users with the corresponding mobile communication operators. In this instance, there is provided a method and apparatus for configuring/changing/erasing, for a unified data management (UDM), edge computing service roaming related information including an operator network list (VPLMN list) that an edge computing service provided by a predetermined ECSP is capable of using.

A method according to an embodiment of the disclosure is a method of providing edge configuration server (ECS) information by a session management function (SMF) device to a user equipment (UE) in a mobile communication system supporting a mobile edge computing (MEC) service, and the method may include an operation of receiving, from the UE via an access and mobility management function (AMF) device, a protocol data unit (PDU) session establishment request message including a protocol configuration option (PCO) indicating that an edge enabler client (EEC) of the UE supports transmission/reception of the ECS information; an operation of receiving, from a unified data management (UDM) device, UE related information including ECS provider information; an operation of determining whether to transmit the ECS provider information to the UE based on the UE related information; and an operation of transmitting, to the UE through the AMF, the PCO including the ECS provider information.

An apparatus according to an embodiment of the disclosure may be a session management function (SMF) device for providing edge configuration server (ECS) information to a user equipment (UE) in a mobile communication system supporting a mobile edge computing (MEC) service, and the SMF device may include a network interface configured to communicate with at least one application function (AF) device; a memory; and at least one processor, wherein the processor is configured to perform: an operation of receiving a protocol data unit (PDU) session establishment request message including a protocol configuration option (PCO) indicating that an edge enabler client (EEC) of the UE supports transmission/reception of the ECS information from the UE via an access and mobility management function (AMF) device using the network interface, an operation of receiving, from a unified data management (UDM) device, UE related information including ECS provider information, an operation of determining whether to transmit the ECS provider information to the UE based on the UE related information, and an operation of transmitting, to the UE through the AMF, the PCO including the ECS provider information.

A method according to another embodiment of the disclosure is a method of providing edge configuration server (ECS) information by a unified data management (UDM) device to a session management function (SMF) device in a mobile communication system supporting a mobile edge computing (MEC) service, and the method may include an operation of receiving ECS provider information from an ECS through a network exposure function (NEF) device; an operation of storing the ECS provider information; and an operation of transmitting, to the SMF, UE related information including the ECS provider information in a case in which the SMF requests the ECS provider information.

An apparatus according to another embodiment of the disclosure is a unified data management (UDM) device for providing edge configuration server (ECS) provider information to a session management function (SMF) device in a mobile communication system supporting a mobile edge computing (MEC) service, and the UDM may include a network interface configured to communicate with at least one application function (AF) device; a memory; and at least one processor, wherein the processor is configured to perform: an operation of receiving the ECS provider information from an ECS through a network exposure function (NEF) device using the network interface, an operation of storing the ECS provider information, and an operation of transmitting UE related information including the ECS provider information to the SMF using the network interface in a case in which the SMF requests the ECS provider information.

In accordance with an aspect of the disclosure, whether to establish a new session may be determined (or identified) by a UE and a network edge computing service provider.

In accordance with an aspect of the disclosure, a mobile communication network that supports edge computing may determine (or identify) whether a session establishment request from a UE is for an edge computing service, and may transfer edge computing service information when it is required, so as to reduce unnecessary signaling.

In accordance with an aspect of the disclosure, in the case of providing a roaming service to a UE, whether an edge computing service is supportable is determined (or identified), and edge computing service information available in a network to be accessed via roaming may be transferred.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an example of an edge computing implementation scenario configured without distinguishing layers according to various embodiment of the present disclosure;

FIG. 2 is a diagram illustrating a layered structure of an edge computing application according to various embodiment of the present disclosure;

FIG. 3 illustrates a signal flowchart when an ECS configures ECSP information for a UDM via an AF according to a first embodiment of the present disclosure;

FIG. 4 is a signal flowchart illustrating the case of selectively providing ECSP information when a UE requests establishment of a PDU session according to a second embodiment of the present disclosure;

FIG. 5 is a signal flowchart illustrating an example of changing/erasing ECSP information according to a third embodiment of the present disclosure; and

FIG. 6 illustrates a functional block diagram of an NF device according to various embodiments of the present disclosure.

### DETAILED DESCRIPTION

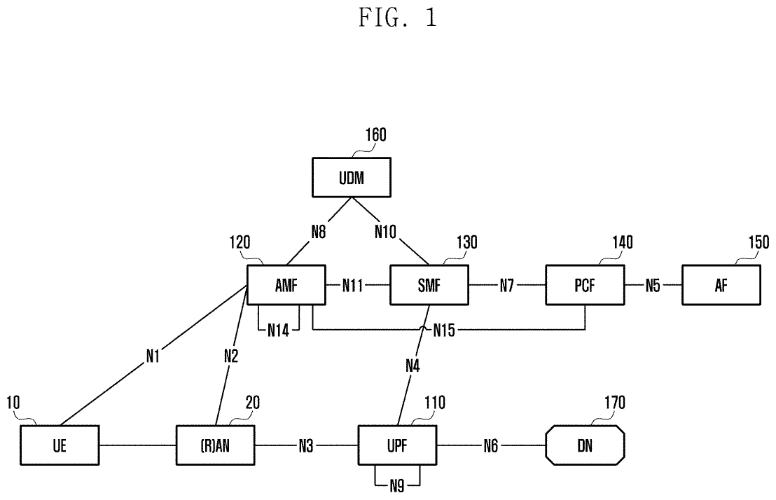

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operational principle of the disclosure will be described in detail with reference to the accompanying drawings. Terms described below are defined in consideration of their functions in the disclosure. This may be changed depending on the intention, practice, or the like of a user or an operator, and thus, the definitions thereof may be determined based on the overall content of the specification.

In the disclosure, terms denoting a network entity and entities of an edge computing system, terms denoting messages, terms denoting identification information, and the like are used for ease of description. Therefore, the disclosure is not limited to the terms provided below, and other terms that denote subjects having equivalent technical meanings may be used.

In the descriptions provided below, for ease of description, although terms and names defined in the 5G system standard are used, the disclosure is not limited to the terms and names and may be equally applied to a system operating according to another standard.

FIG. 1 is a diagram illustrating an example of an edge computing implementation scenario configured without distinguishing layers according to various embodiments of the present disclosure.

Before referring to FIG. 1, the elements of FIG. 1 correspond to a block diagram of a network based on a 5G system architecture. The 5G system architecture may include various elements, for example, network function (NF) devices. It should be construed that FIG. 1 illustrates a part of them.

FIG. 1 illustrates an access and mobility management function (AMF) device 120, a session management function (SMF) device 130, a policy control function (PCF) device 140, an application function (AF) device 150, a unified data management (UDM) device 160, a data network (DN) 170, a user plane function (UPF) device 110, a (radio) access network ((R)AN) 20, and a user equipment (UE) 10.

Each NF device illustrated in FIG. 1 may be embodied in a single server, or the function of a single NF device may be implemented in two or more servers. In addition, NF devices may include a plurality of NF devices that perform the same function. For example, two or more UPFs 110 may be used, and also two or more AMFs 120 may be used. Two or more NF devices that perform the same function may be embodied in a single server, or may be embodied in different servers. The case in which NF devices are embodied in a single server may be, for example, the case of providing services corresponding to different PDU sessions to a single UE or different UEs in the same area. In addition, the case in which NF devices are embodied in different servers may correspond to the case in which the NF devices are located in different areas. In the descriptions below, a predetermined “NF device” will be described as an NF device or an “NF.” For example, it should be construed that the SMF device 130 and the SMF 130 are the same.

In addition, a single NF and/or two or more NFs may be embodied as a single network slice. A network slice may be provided in the form in which a single NF and/or two or more NFs operate as a single virtual network and provide the same service to a predetermined user and/or user group.

The function and operation supported by each of the NFs illustrated in FIG. 1 will be briefly described.

The AMF 120 may provide an access and mobility management function in units of UEs, and a single AMF may be basically accessed by single UE.

The DN 170 may be, for example, an operator service, an Internet access, or a 3rd party service, or the like. The DN 170 may transmit a downlink protocol data unit (PDU) to the UPF 110, or may receive a PDU transmitted from the UE 10 via the UPF 110.

The PCF 140 may receive information associated with a packet flow from an application server, and may provide a function of determining a policy associated with mobility management, session management, and the like. Particularly, the PCF 140 may support a function of supporting a unified policy framework to control network operations, a function of providing policy rules so that a control plane function(s) (e.g., the AMF 120, the SMF 130, and the like) implements the policy rules, a function of implementing a front end for accessing related subscription information for determining a policy in a user data repository (UDR) 180.

The SMF 130 may provide a session management function, and in the case in which the UE 10 has a plurality of sessions, each session may be managed by each different SMF.

The UDM 160 may store user subscription data, policy data, and the like.

The UPF 110 may transfer a downlink PDU received from the DN 170 to the UE 10 via the (R)AN 20 in the downlink, and may transfer an uplink PDU received from the UE 10 via the (R)AN 20 to the DN 170.

The AF 150 may interoperate with a 3GPP core network in order to support functions, for example, application effect on traffic routing, access to network capability exposure, and interoperating with a policy framework for policy control.

The (R)AN 20 may be a base station that is in charge of performing transmission and reception of data/signal/message with the UE 10 via radio access technology in a mobile communication network. For example, data provided from the DN 170 to the UE 10 via the UPF 110 may be provided to the UE 10 using a mobile communication access technology, and data transmitted from the UE 10 using the mobile communication access technology may be transmitted to the DN 170 via the UPF 110.

The UE 10 may be a user equipment, and may be call differently depending on a radio access technology, for example, a terminal, an access terminal, a mobile terminal, a mobile device or mobile equipment, a mobile note, and the like. As a representative device of the UE 10, there may various forms of devices such as a smartphone, a portable phone, a mobile terminal, a smart watch, a tablet computer, a notebook computer, a personal computer, a vehicle equipped with a radio access function, and the like. That is, that may be an IoT device and/or various devices equipped with an IoT function. The UE 10 may be provided in one of the various forms that are capable of receiving an edge computing service according to the disclosure described below.

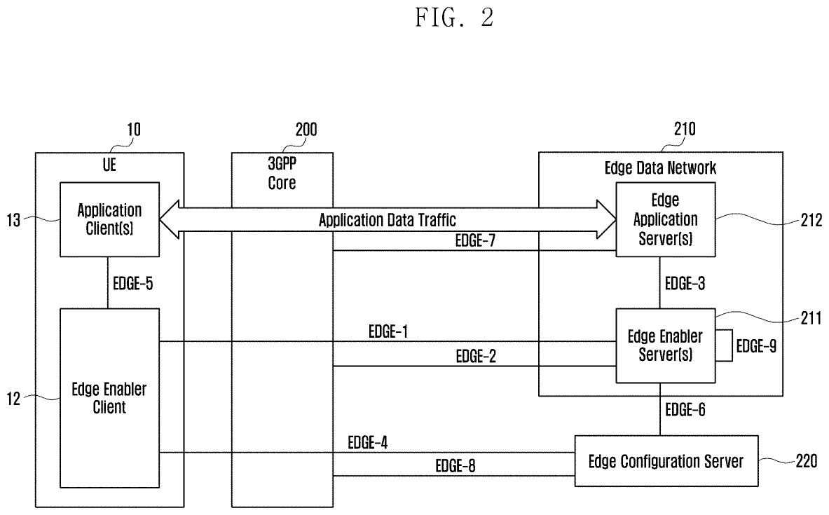

FIG. 2 is a diagram illustrating a layered structure of an edge computing application according to various embodiments of the present disclosure.

Referring to FIG. 2, a network and edge computing entities will be described.

FIG. 2 illustrates the UE 10 and a 3GPP core network 200 as an example of a mobile communication network. In addition, FIG. 2 includes an edge data network 210 and an edge data network configuration server (or an edge configuration server (ECS)) 220. The edge data network 210 may include an edge enabler server (EES) 211 and an edge application server(s) (EAS) 212. In addition, the UE 10 may include an edge enabler client (EEC) 12 and an application client 120. Although not illustrated in FIG. 2, the UE 10 may further include a mobile terminal (MT). The MT may be a configuration to enable a UE to perform transmission/reception of data/signal/message with the 3GPP core 200 using the (R)AN 20 and a radio access technology. The MT may be embodied as, for example, a modem, or may include a modem, a wireless processing unit, and an antenna.

In addition, the configuration of the UE 10 in FIG. 1 and FIG. 2 illustrates internal blocks in terms of operations associated with the disclosure. However, it is apparent to those skilled in the art that additional elements can be further included depending on the various types of UEs 10. For example, a memory, an input unit for providing an interface to a user, an output unit or the like may be further included. As the input unit of the UE 10, at least one among a key for recognizing a user input, a touch pad, a biometric recognition sensor, and a stylus may be included. As the output unit of the UE 10, at least one of various types of output units such as a display, a lamp, a vibration motor, a speaker, a beam projector, and the like may be included.

An edge computing system may include the EES 211, the ECS 220, and the EEC 12 in the UE 10. The EES 211 may establish an edge hosting environment or edge computing platform, and may be aware of information associated with the EAS 122 that operates in the edge hosting environment.

The EES 211 may negotiate with the UE 10 so as to perform a function of connecting an application client 13 of the UE 10 and the EAS 212 of the edge hosting environment. The EEC 12 mounted (or embedded) in the UE 10 that supports the edge computing system may perform negotiation in order to receive an edge computing service via interoperation with the EES 211. A layer in which the EEC 12 and the EES 211 perform interoperation (or negotiation) is referred to as an edge enabling layer.

The ECS 220 may be aware of deployment information of the EES 211, and may perform a function of transferring, to the UE 10, configuration information for using an edge computing service. The configuration information may include edge data network connection information (e.g., a data network name, a single-network slice selection assistance information (S-NSSAI), or the like), an edge data network service area (e.g., a cell list, a list of tracking area, a PLMN ID), an edge enabler server connection information (e.g., URI), or the like. The edge data network service area may be an EES-enabled area set by the EES 211. Based on the above, the UE 10 may receive information associated with the EES 211 that is accessible at a predetermined location. In the case in which the ECS 220 is capable of being aware of information associated with the EAS 212 that is operating in the edge hosting environment of a predetermined EES 211, the UE 10 may be capable of obtaining the corresponding information via the EEC 12.

The EAS 212 is a third party application server that operates in the edge computing system. The EAS 212 is a third application server that operates in an infrastructure provided by the edge hosting environment, and may provide a service at a location close to the UE 10, and thus, may provide an ultra-low latency service.

As described above, the UE 10 may include the application client 13, the edge enabler client 12 that interoperates with the application client 13 for an edge computing service, and a mobile terminal (MT) that accesses a mobile communication system although not illustrated in FIG. 2. The application of the UE 10 may be an application provided by a third party, and may be a client application program that operates in the UE 10 for a predetermined application service. A single application or two or more applications may operation in the UE 10. In the case in which two or more applications operate, at least one of the operating applications may use a mobile edge computing (MEC) service. The EEC 12 in the UE 10 may be a client that performs operations in the UE 10 that are needed for an edge computing service. The EEC 12 may determine (or identify) which application is capable of using an edge computing service, and may perform an operation of connecting a network interface so as to transfer data of the application client of the UE 10 to the EAS 212 that provides the edge computing service.

Actually, the EEC 12 may perform an operation of establishing a data connection for using an edge computing service via an MT in a 3GPP communication layer. That is, the EEC 12 may control the MT so as to perform data connection for using an edge computing service in the 3GPP communication layer. The 3GPP communication layer may be a layer that performs a modem operation for using a mobile communication system, may establish a wireless connection for data communication, may register the UE 10 with the mobile communication system, may establish a connection for data transmission to the mobile communication system, and may perform a function of data transmission or reception.

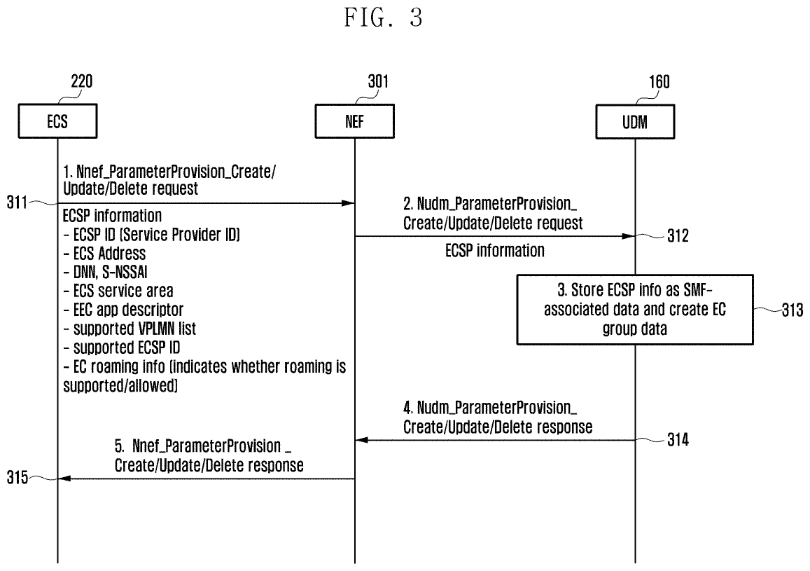

FIG. 3 is a signal flowchart when an ECS configures ECSP information for a UDM via an AF according to a first embodiment of the present disclosure.

The first embodiment will be described with reference to FIG. 3 and the network functions which have been described with reference to FIGS. 1 and 2. A network exposure function (NEF) device 301 which has not been described in FIG. 1 will be briefly described first.

The NEF 301 may be a network entity that is capable of accessing information that manages the UE 10 in a 5G network, that may subscribe to a mobility management event associated with the corresponding UE 10, that may subscribe to a session management event associated with the corresponding UE 10, may request session related information, may set charging information associated with the corresponding UE 10, may request changing of a PDU session policy associated with the corresponding UE 10, and may transmit small data associated with the corresponding UE 10.

Referring to FIG. 3, in operation 311, the ECS 220 may be an AF and may provide ECSP information to the NEF 301 using an NEF parameter provision create/update/delete (Nnef_ParameterProvision_Create/Update/Delete) request message. As another method, the ECS 220, as an AF, may utilize another service request message such as Nnef_ServiceParameter, in order to provide ECSP information to the NEF 301.

The ECSP information may include at least one piece of information among the following information:
ECSP ID: an edge computing service provider identifier (e.g., an edge computing service provider may be a subject that provides and manages the ECS 220 and the EEC 211. In addition, the edge computing service provider may be a subject that provides and manages the EAS 212 in addition to the ECS 220 and the EES 211;
ECS 200 address;
DNN and S-NSSAI needed for establishing a session for accessing the ECS 220;
Service (jurisdiction) area of the ECS 220;
EEC application descriptor information accessible to the ECS 220 (OS app ID of the EEC 12, an application port ID of the EEC 12, or the like), an EEC identifier, or an EEC software package name information;
a PLMN list (e.g., a VPLMN list or VPLMN ID list) capable of receiving a service from an ECSP;
Another ECSP ID list agreed upon with the ECSP (including an ECSP ID that shares the ECS 220 or ECSP ID information supportable by an VPLMN));
Edge computing roaming information: information including whether an edge computing service provided by an ECSP identified by an ECSP ID supports roaming. If the roaming of the edge computing service is supported, PLMN information that supports roaming (a PLMN list capable of receiving a service from an ECSP) needs to be provided together from the ECS 220. The information may be determined based on a roaming agreement between a mobile communication network operator and an edge computing service provider;
Application function ID; and/or
An edge computing user group identifier (UE group identifier for edge computing service): Information for identifying a group of subscribers capable of using an edge computing service provided by a corresponding ECSP.

In operation 312, the NEF 301 may transfer ECSP information provided from the ECS 220 to the UDM 160.

In operation 313, the UDM 160 may store ECSP information received from the NEF 301 as session management subscriber information, or may store as SMF-associated data, and may identify the subscription information of the UE 10 so as to produce an edge computing service group. The edge computing service group may include a list of subscriber UEs 10 capable of receiving a service from a predetermined edge computing service provider, and configuration information (ECSP information) for using a corresponding service. Therefore, the UDM 160 may store a subscriber list included in the ECSP information and a service group of users capable of receiving an edge computing service provided from an ECSP using corresponding service information, as configuration information, or session management subscriber information, or SMF-associated data.

In addition, in the case in which ECSP information excluding service group identifiers of users capable of receiving an edge computing service is received, the UDM 160 may store session management subscriber information associated with all UEs, or may store ECSP information associated with all UEs as SMF-associated data. In this instance, the UDM 160 may store ECS address information included in the ECSP information together with session management subscriber information associated with a DNN and an S-NSSAI included in the received ECSP information, and may identify corresponding ECSP information when performing a PDU session establishment and changing procedure associated with the corresponding DNN and S-NSSAI, and may provide the same to a network function such as the SMF 130.

Subsequently, the UDM 160 may transmit, to the NEF 301, information indicating that ECSP information is successfully configured in operation 314.

In operation 315, the NEF 301 may transfer, to the ECS 220, the information indicating whether the ECSP information is successfully configured, received from the UDM 160.

Through the above-described operations, the ECS 220, as an AF, may provide the ECSP information to the UDM 160, so as to configure the ECSP information. Therefore, the UDM 160 may store the ECSP information provided from the ECS 220, and subsequently, may provide information associated with a UE that desires to receive a predetermined edge computing service to a predetermined NF in the 3GPP core network 200. In the operations which have been described with reference to FIG. 3, the ECS 220, as an AF, may provide the ECSP information to the UDR 180, instead of configuring the ECSP information for the UDM 160. In this instance, the ECS 220 may provide the ECSP information to the NEF 301, and the NEF 301 may transfer the received ECSP information to the UDR 180. The UDR 180 may store the ECSP information received from the NEF 301. In addition, the UDR 180 may transfer, to the PCF 140, the ECSP information received from the NEF 301. The PCF 140 may transfer the ECSP information to the SMF 130.

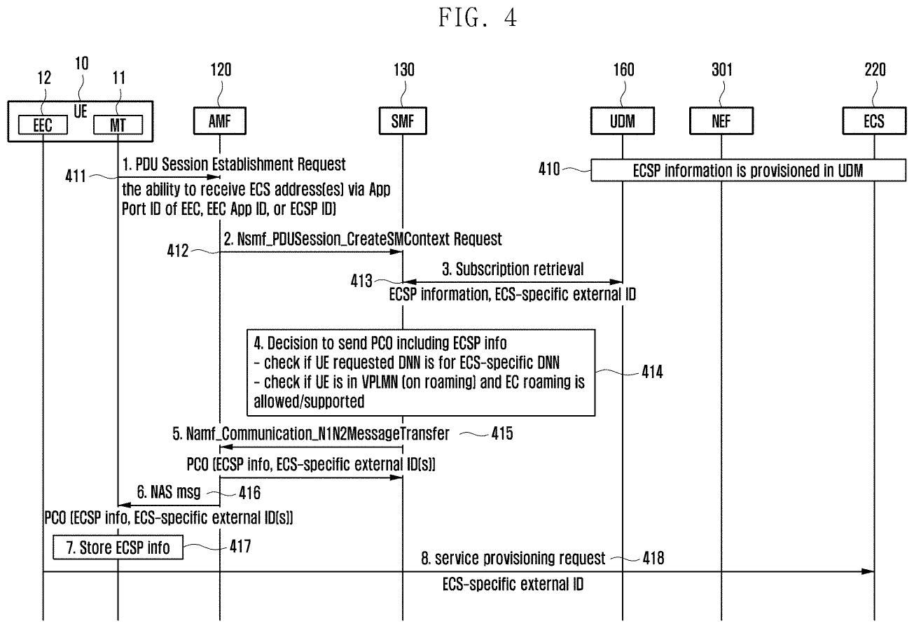

FIG. 4 is a signal flowchart illustrating the case of selectively providing ECSP information when a UE requests establishment of a PDU session according to a second embodiment of the present disclosure.

Operation 410 of FIG. 4 may include all of the operations performed according to the first embodiment of FIG. 3 and/or at least some of the operations performed according to the first embodiment of FIG. 3, which have been described above. Therefore, operation 410 of FIG. 4 will not be additionally described.

In operation 411, the UE 10 may include EEC related information contained in the UE 10 in a protocol configuration option (PCO) when transmitting a PDU session establishment request message to the AMF 120.

The EEC related information may include at least one piece of information among the following information:
Information indicating whether the EEC 12 is installed in the UE 10 and whether the EEC 12 is capable of interoperating with a modem;
EEC application identifier (application ID) or EEC application port identifier (application port ID); and/or
An ECSP ID capable of providing a service to the EEC 12.

In operation 412, the AMF 120 may transfer the session establishment request message received from the UE 10 to the SMF 130.

In operation 413, after the SMF 130 receives the PDU session request from the AMF 120, the SMF 130 may receive (obtain) UE 10-related information from the UDM 160.

The UE-related information obtained from the UDM 160 may include one or more pieces of information among the following information:
ECSP information: the ECSP information may be information configured (or stored) in the UDM 160 in the same manner as the above-described first embodiment, or may be information that is locally configured in the UDM 160; and/or
An external identifier of a UE that is dedicated for an edge computing service provider specified by ECSP information.

In the case in which the SMF 130 receives the above-described first information and second information from the UDM 160, the SMF 130 may provide information (an ECSP ID, an EEC application ID, or an EEC application port ID) included in a PCO received from the UE 10 to the UDM 160, and may obtain ECSP information corresponding thereto

In operation 414, the SMF 130 may identify information included in the PDU session establishment request message received via the AMF 120 and information obtained from the UDM 160, may determine the ECSP information of which ECSP is to be transmitted to the UE 10, or may determine (or identify) whether a PDU session of which establishment is requested is a PDU session related to the usage of an edge computing service. Here, the identifying of the two types of information may be an operation of comparing the information obtained from the UDM 160 and information included in the PDU session establishment request message received via the AMF 120, and of identifying whether the two types of information are identical.

In addition, as an example of the determination, one of the following methods may be used, or two or more methods among the following methods may be used together.

In one example of method (1), in the case in which DNN and S-NSSAI information included in a message (Nsmf_PDUSession Create/UpdateSMContext) that the AMF 120 transmits to the SMF 130 after receiving a PDU session establishment message requested by the UE 10 (the AMF 120 may receive the corresponding DNN and S-NSSAI information from the UE 10, and transfer the same to the SMF 130, or the AMF 130 may change the DNN and S-NSSAI based on subscriber information and may transfer the same to the SMF 130) is identical to the DNN and S-NSSAI included in the ECSP information obtained from the UDM 160, the SMF 130 may determine (or identify) that the corresponding session connection request is associated with an edge computing service. Based on the determination, the SMF 130 may determine to transmit, to the UE 10, the ECSP information associated with the PDU session of which establishment is requested. In addition, the SMF 130 may compare the DNN and S-NSSAI information included in the PDU session establishment related message received from the AMF 120 and the DNN and S-NSSAI information received from the PCF 140, and may determine (or identify) whether the corresponding session connection request is associated with an edge computing service, and in the case in which a PDU session of which establishment is requested is associated with an edge computing service, the SMF 130 may determine to transfer the ECSP information to the UE 10.

In one example of method (2), the SMF 130 may determine whether an EEC application ID, an application port ID, or an ECSP ID included in a PCO in a PDU session establishment request message received from the UE 10 and an EEC application, an application port ID, or an ECSP ID in the ECSP information obtained from the UDM 160 are present (or compared or identified). In the case in which it is identified that corresponding ECSP information is present by identifying the PCO received from the UE 10 and the ECSP information obtained from the UDM 160, the SMF 130 may determine to transfer the ECSP information including ECS address information to the UE 10. As another method, the SMF 130 may compare the DNN and S-NSSAI information included in the PDU session establishment message received from the AMF 120 and the DNN and S-NSSAI information received from the PCF 140 and may determine (or identify) whether the corresponding session connection request is associated with an edge computing service. The information that SMF 130 obtains from the PCF 140 and uses for comparison may be ECSP information that the ECS 220 stores in the UDR 180 via the NEF 301.

In one example of method (3), in the case in which the UE 10 that has sent a PDU session establishment request is in a roaming state, the SMF 130 may identify the following items in the ECSP information obtained from the UDM 160 of HPLMN and may determine whether to transfer ECS address information. The SMF 130 may identify whether roaming of an edge computing service for the corresponding UE 10 is supported, and in the case in which roaming of the edge computing service for the corresponding UE 10 is supported, the SMF 130 may identify whether a current VPLMN ID is included in the list of VPLMNs capable of supporting edge computing service roaming. If the current VPLMN supports edge computing service roaming, the SMF 130 may identify ECSP ID list (supported ECSP ID) that can be supported in the current VPLMN, and may determine ECSP information to be transferred to the UE 10.

One of the methods (1) to (3) may be used or two or more of them may be used together. For example, some of method (1) and/or method (2) may be used for method (3). More particularly, the UE 10 may request establishment of a PDU session using at least one of method (1) or method (2). Subsequently, the SMF 130 may use ECSP information obtained from the UDM 160 of HPLMN according to method (3), and may determine ECSP information to be transferred to the UE 10 based thereon.

In operation 415, in the case in which the SMF 130 determines the ECSP information to be transmitted to the UE 10 in operation 414, the SMF 130 may transfer the corresponding ECSP information in the PCO and may transmit the same to the AMF 120. In the case in which an external identifier of the UE 10 that is dedicated for an edge computing service provider identified by an ECSP ID included in the ECSP information, is obtained from the UDM 160, the external identifier may be included in the PCO and may be transferred to the AMF 120. The AMF 160 may transfer, to the SMF 130, a response message including information indicating whether reception is successfully performed.

In operation 416, the AMF 120 may transfer the PCO including the ECSP information transferred from the SMF 130 to the UE 10 via an NAS message.

In operation 417, the MT 11 in the UE 10, for example, a modem, may store the ECSP information (an ECS address, an ECSP ID, a DNN, an S-NSSAI, an ECS service area, and the like) received via the NAS message in an embedded memory (not illustrated), and may provide the same to the EEC 12 in a higher layer in the UE 10. In FIG. 4, since a procedure in which the MT 11 provides the ECSP information to the EEC 12 is a procedure performed inside the UE 10, it should be construed that the procedure is not illustrated in FIG. 4.

In operation 418, the EEC 12 in the UE 10 may transmit a service provisioning request message to the ECS 220 using the ECS information in the ECSP information provided from the MT 11. In the case in which an external identifier of the UE 10 that is dedicated for the ECSP is provided together, the corresponding identifier may be included in the service provisioning request message and may be transmitted to the ECS 220.

As described above, although the first embodiment and the second embodiment may be separate embodiments, configuration may be performed so that stored information according to the first embodiment may be used in the second embodiment. Therefore, although the first embodiment and the second embodiment are merely described separately for ease of description, and it should be construed that they are not different examples in a single overall operation. That is, one of the first embodiment and the second embodiment may be independently used or the first embodiment and the second embodiment may be applied together. A third embodiment to be described below may be understood in the same manner as the relationship between the first embodiment and the second embodiment.

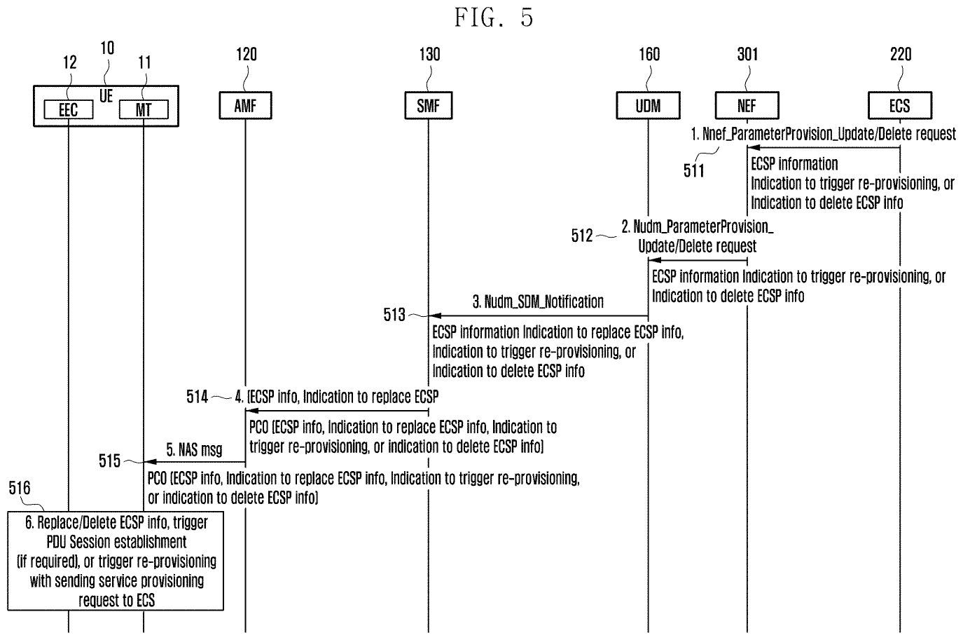

FIG. 5 is a signal flowchart illustrating an example of changing/erasing ECSP information according to a third embodiment of the present disclosure.

FIG. 5 illustrates the case of utilizing a PDU session modification procedure in the third embodiment. However, in the case in which a message for changing/erasing ECSP information is capable of being transmitted/received as described in the disclosure according to another scheme, as opposed to a PDU session modification procedure, the case using the other scheme may be included in the embodiments of the disclosure.

In addition, the third embodiment illustrated in FIG. 5 may correspond to the case of modifying and/or erasing a PDU session after providing ECSP information to a UE via all of the operations or some operations of FIG. 4 which have been described.

Hereinafter, operations in a procedure that changes ECSP information in the UDM 160 when ECS related information is changed will be described will be described with reference to FIG. 5.

In operation 511, the ECS 220 may transmit, to the NEF 310, information including at least one piece of information among the following information, so as to inform the UDM 160 that the ECSP information has changed or erased:
Changed ECSP information (a changed ECS address, a changed DNN, an S-NSSAI, a changed ECS service area, a changed supported VPLMN list, or the like). In the case in which the changed ECSP information is transmitted, the ECS 220 may include the corresponding changed information in an Nnef_ParameterProvision Update request message transmitted to the NEF 301;
An indication to trigger re-provisioning of the EEC 12 The corresponding indicator may be included in the Nnef_ParameterProvision Update request message; and/or
An indication to delete ECSP info (ECSP information erasure indicator associated with termination of an ECSP service). The corresponding indicator may be included in the Nnef_ParameterProvision Delete request message.

In operation 512, the NEF 301 may transmit an NEF parameter provision update/delete (Nnef_ParameterProvision Update/Delete) request message received from the ECS 220 to the UDM 160.

The UDM 160 that receives the Nnef_ParameterProvision Update/Delete request message may transfer at least one piece of information among the following information to the SMF 130 according to the Nnef_ParameterProvision Update/Delete request message received from the NEF 301 in operation 513:

(1) In the case in which changed ECSP information is received from the NEF 301, the UDM 160 may include at least one of the changed information and indication to replace ECSP info in a Nudm_SDM_Notification message, and may transmit the same to the SMF 130;

(2) In the case in which changed ECSP information and an indication to trigger re-provisioning of the EEC 12 are received from the NEF 301, the UDM 160 may include at least one of the changed information and the indication to replace ECSP info in a Nudm_SDM_Notification message and may transmit the same to the SMF 130;

(3) In the case in which only an indication to trigger re-provisioning of the EEC 12 is received from the NEF 301, the UDM 160 may include the same in a Nudm_SDM_Notification message and may transmit the same to the SMF 130; and/or

(4) In the case in which an Nnef_ParameterProvision Delete request message (a message including an indication to delete ECSP info) is received from the NEF 301, the UDM 160 may include an indication to delete ECSP info indicator in a Nudm_SDM_Notification message, and may transmit the same to the SMF 130.

In operation 514, the SMF 130 may include the information received from the UDM 160 in operation 513 in a PCO, and may transmit the same to the AMF 120. The AMF 120 may transfer, to the SMF 130, a response message including information indicating whether reception is successfully performed. In the embodiment described with reference to FIG. 5, only the case in which the SMF 130 transfers ECSP information received from the UDM 160 to the AMF 120 while a PDU session modification procedure is performed has been described, the SMF 130 may obtain the corresponding information from the PCF 140. The case in which the SMF 130 is capable of obtaining the ECSP information from the PCF 140 may be the case in which the ECS 220, as an AF, stores the ECSP information in the UDR 180 via the NEF 301.

In operation 515, the AMF 120 may transfer the PCO received from the SMF 130 to the UE 10.

In operation 516, the UE 10 that receives the PCO may perform at least one operation among the following operations based on information included in the PCO received from the AMF 120:
(1) In the case in which changed ECSP information and indication to replace ECSP information are included in the PCO, the UE 10 may change ECSP information stored in the current MT 11 according to the received information; and/or
(2) In the case in which changed ECSP information and the indication to trigger re-provisioning of the EEC 12 are included in the PCO, the UE 10 may use ECS address information and DNN and S-NSSAI information included in the changed ECSP information, so as to transmit a service provisioning request message to an ECS corresponding to the ECS address included in the ECSP information. Particularly, in the case in which changed DNN and S-NSSAI information is received, the UE 10 may identify whether a data network accessible via a currently established PDU session is a data network accessible via the received DNN and S-NSSAI. In the case in which a PDU session that is connectable to the data network accessible via the received DNN and S-NSSAI is not present, the UE 10 may establish a new PDU session before transmitting a service provisioning request message, and may transmit a service provisioning request message to the ECS corresponding to the ECS address included in the ECSP information via the newly established PDU session.

In the case in which only the indication to trigger re-provisioning of the EEC 12 is included in the PCO, a service provisioning request message may be transmitted again to the ECS 220 configured for the current UE 10. In this instance, a PDU session may not need to be newly established.

In the case in which an indication to delete ECSP info indicator is included in the PCO, ECSP information stored currently in the current MT 11 or the EEC 120 may be deleted. In addition, the EEC 12 may utilize ECS information that is locally configured, or may drive an ECS address from a PLMN ID that the UE 10 currently accesses and may use the same to transmit a service provisioning request message.

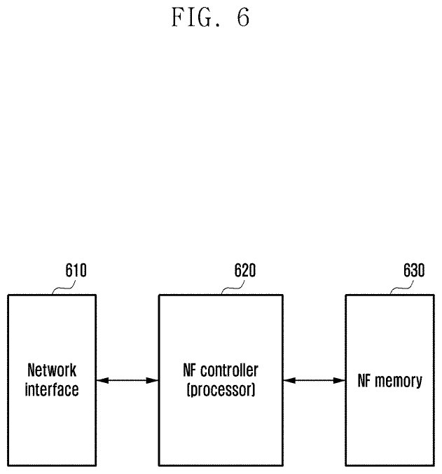

FIG. 6 illustrates a functional block diagram of an NF device according to various embodiments of the present disclosure.

Referring to FIG. 6, a network interface 610, an NF controller 620, and an NF memory 630 may be included.

The network interface 610 may provide an interface for communication with another NF. For example, in the case in which an NF is the NEF 301, an interface for communicating with the UDM 160 may be provided. In addition, if the NF is the UPF 110, an interface with the RAN 20 may be included. As another example, in the case in which the NF is the SMF 130, an interface for communicating with the UPF 110, the AMF 120, the PCF 140, and/or the UDM 160 may be included. In this instance, the network interface 610 may provide an interface for transmitting or receiving various types of control messages/signals/data described with reference to FIGS. 4 and/or 5. In the case of the ECS 220 and/or the EAS 212 and/or EES 211 located in an edge data network, an interface for transmitting or receiving various control message/signal/data may be equally provided.

The NF controller 620 may control operations of a corresponding NF. For example, if the NF is the NEF 301 or the UDM 160, the NF controller 620 may perform control corresponding to the operation of the NEF 301 or the UDM 160 which has been described with reference to FIGS. 3 to 5. In addition, in the case in which the NF is the SMF 130 and/or AMF 120, the NF controller 620 may perform control so as to perform an operation corresponding to the SMF 130 and/or AMF 120 which has been described with reference to FIGS. 4 to 5. In addition, in the case in which the NF is the ECS 220 and/or the EAS 212 and/or EES 211 located in an edge data network, the NF controller 620 may perform control of operations described with reference to FIGS. 3 to 5.

The NF memory 630 may store information for controlling an NF, information produced while control is performed, and information required according to the disclosure. For example, the NF memory 630 may store information which has been described with reference to FIGS. 3 to 5. For example, in the case in which the NF is the SMF 130, ECSP information and information included in an PCO may be stored in the NF memory 630. In addition, other NFs may receive a signal/message described with reference to FIGS. 3 to 5, and may temporarily store the same or may store the same to use in the future.

Although the detailed descriptions of the disclosure describe detailed embodiments, various modifications are allowed within the scope of the disclosure. Therefore, the scope of the disclosure should not be limited to the above-described embodiments, and should be defined by the scope of claims set forth below and the equivalents thereto.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a session management function (SMF) for providing edge configuration server (ECS) provider information to a user equipment (UE) in a mobile communication system supporting a mobile edge computing (MEC) service, the method comprising:
receiving, from the UE via an access and mobility management function (AMF), a protocol data unit (PDU) session establishment request message including a protocol configuration option (PCO) indicating that an edge enabler client (EEC) of the UE supports an ECS;
receiving, from a unified data management (UDM), UE information including first ECS provider information;
determining whether to transmit the first ECS provider information to the UE based on the UE information; and
transmitting, to the UE via the AMF, the PCO including the first ECS provider information.

2. The method of claim 1, wherein the first ECS provider information includes at least one of an ECS provider identifier, an ECS service area, an ECS address, or a PLMN identifier list.

3. The method of claim 1, wherein the PCO is transmitted, by the AMF, to the UE using a non-access-stratum (NAS) message.

4. The method of claim 1, further comprising:
receiving, from the UDM, a notification message included in second ECS provider information that is updated from the first ECS provider information; and
transmitting, to the UE via the AMF, the PCO including the second ECS provider information.

5. The method of claim 1, wherein the ECS provider information is associated with an ECS provider that is a provider of the MEC service.

6. A session management function (SMF) for providing edge configuration server (ECS) provider information to a user equipment (UE) in a mobile communication system supporting mobile edge computing (MEC) service, the SMF comprising:
a network interface configured to communicate with at least one application function (AF);
memory; and
at least one processor configured to:
control the network interface to receive, from the UE via an access and mobility management function (AMF), a protocol data unit (PDU) session establishment request message including a protocol configuration option (PCO) indicating that an edge enabler client (EEC) of the UE supports an ECS,
control the network interface to receive, from a unified data management (UDM), UE information including first ECS provider information,
determine whether to transmit the first ECS provider information to the UE based on the UE information, and
control the network interface to transmit, to the UE via the AMF, the PCO including the first ECS provider information.

7. The SMF of claim 6, wherein the first ECS provider information includes at least one of an ECS provider identifier, an ECS service area, an ECS address, or a PLMN identifier list.

8. The SMF of claim 6, wherein the PCO is transmitted, by the AMF, to the UE using a non-access-stratum (NAS) message.

9. The SMF of claim 6, wherein the at least one processor is further configured to:
control the network interface to receive, from the UDM, a notification message included in second ECS provider information that is updated from the first ECS provider information; and
control the network interface to transmit, to the UE via the AMF, the PCO including the second ECS provider information.

10. The SMF of claim 6, wherein the ECS provider information is associated with an ECS provider that is a provider of the MEC service.

11. A method of a unified data management (UDM) for providing edge configuration server (ECS) provider information to a session management function (SMF) in a mobile communication system supporting a mobile edge computing (MEC) service, the method comprising:
receiving, from an ECS via a network exposure function (NEF), first ECS provider information including at least one of an ECS provider identifier, an ECS service area, or an address of the ECS;
storing the first ECS provider information; and
transmitting, to the SMF, UE information including the first ECS provider information, when the SMF requests the ECS provider information.

12. The method of claim 11, further comprising:
receiving, from the ECS, second ECS provider information; and
transmitting, to the SMF, a notification message included in the second ECS provider information.

13. The method of claim 11, wherein the ECS provider information is associated with an ECS provider that is a provider of the MEC service.

14. A unified data management (UDM) for providing edge configuration server (ECS) provider information to a session management function (SMF) in a mobile communication system supporting mobile edge computing (MEC) service, the UDM comprising:
a network interface configured to communicate with at least one application function (AF);
memory; and
at least one processor configured to:
control the network interface to receive, from the ECS via a network exposure function (NEF), first ECS provider information including at least one of an ECS provider identifier, an ECS service area, or an address of the ECS,
store the first ECS provider information, and
control the network interface to transmit, to the SMF, UE information including the first ECS provider information when SMF requests the ECS provider information.

15. The UDM of claim 14, wherein the at least one processor is further configured to:
control the network interface to receive, from the ECS, second ECS provider information, and
control the network interface to transmit, to the SMF, a notification message included in the second ECS provider information.
